(19) United States
(12) Patent Application Publication
(10) Pub. No.: US 2007/0192180 A1
(43) Pub. Date: Aug. 16, 2007

(54) Real estate media/prospect tracking system

(76) Inventor: William W. Lange, Newport Beach, CA (US)

Correspondence Address: EDWIN TARVER, 16830 Ventura Blvd., SUITE 360, Encino, CA, 91436, US

(21) Appl. No.: 11/351,624

(22) Filed: Feb. 10, 2006

(51) Int. Cl. G06Q 30/00

(52) U.S. Cl. 705/14

(57) ABSTRACT

An online media/prospective buyer tracking system that allows a seller or auctioneer of real estate to analyze the cost of advertising used to bring prospective buyers to an auction website wherein media codes embedded in the advertising references correspond to individual online web pages capable of recognizing the source of the advertisement that directs each potential buyer to each respective web page. The system recognizes the media code corresponding to an advertisement and assigns a portion of the cost of the advertisement to each site visitor, making calculations regarding the cost per visit to the auction site, the cost per registration, the cost per visit to the respective property, the cost per bid and the cost per winning bid.

### CROSS-REFERENCE TO RELATED APPPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates generally to real estate transactions, more specifically to advertising real estate for sale, and still more specifically to a tracking system that allows a real estate seller to track the sources of prospective buyers using an online system that associates data from prospective buyers with the media source that generated their interest in the property.

In order to announce properties for sale to a broad range of potential buyers, and give preliminary information regarding properties for sale to potential buyers, sellers frequently rely on advertising media. Advertising in print, on the Internet, and even at the site of the property with signage is popular. Property advertising is particularly useful with respect to properties for auction, where multiple buyers vie for the same property.

The Internet provides both a new market, and novel techniques for auctioning products, and provides an interactive environment to sellers of auctioned property. Online auction techniques in the current art discuss methods and systems for selling with a customer centered approach, offering a variety of data controllable by the buyer.

U.S. Pat. No. 6,963,850 to Bezos, et al., discusses a method and system for Computer services for assisting users in locating and evaluating items in an electronic catalog based on actions performed by members of specific user communities. This system takes into account interests of a particular buyer community and advertises the interests at a community common page, notifying interested parties by email.

U.S. Pat. No. 6,970,830 to Samra, et al., discusses a method and system for analyzing marketing campaigns. The method includes the steps of profiling results of the marketing campaign against a list of user defined dimensions (analytic models may be used to derive dimensions) and assigning a score to the results of the marketing campaign.

Although systems currently available in the art provide online auction and guided advertising services, as well as marketing campaign systems and methods, they are customer oriented and fail to provide real-time online feedback to the seller or auctioneer about the cost effectiveness of the advertising that produced the prospective buyer. Therefore it is an object of the present invention to provide a media/prospect tracking system. It is another object of the present invention to provide a system and method for tracking online auctions. Another object of the present invention is to provide an online auction tracking system for property sales. Another object of the present invention is to provide a method and system for tracking buyers or prospects generated by advertising for an online property auction. Another object of the present invention is to provide a method and system that grades buyers or prospects regarding their likelihood of submitting an offer or bid for a property.

### SUMMARY OF THE INVENTION

To achieve above and other objects, the present invention provides a method and system for tracking prospective purchasers of real estate, and providing data to sellers and auctioneers regarding the effectiveness of specific advertisements.

In this system, prospective buyers visiting an online auction web site provide feedback to the host of the site regarding the advertisement that directed them to the auction website. In this manner, the host of the site is able to assess the value of each of the advertisements, placed in various media, for an individual property. By assessing the value of advertising media, sellers and auctioneers are able to place advertisements more effectively; in media outlets providing the most exposure to potential buyers, and ascertain the advertising costs associated with a particular property.

In the method and system of the present invention, advertisements are tracked with the help of media codes. Each type of advertisement, whether print media, Internet, onsite signage, etc., contains a Uniform Resource Locator (URL) which includes media and property codes that are unique to an individual advertisement and to the property that is being advertised.

By using media and property codes, sellers and auctioneers can ascertain the cost effectiveness of advertising, on a real-time, property by property basis. In addition, through the system, data is monitored at various milestones while a property is offered for sale. Although milestones may be customized to meet specialized criteria, several default milestones are automatically monitored by the system.

The system monitors the cost associated with prospective buyer visitations to the property profile page. The media codes of the present invention consist of an alphanumeric code incorporated into the URL of the website on which details of the property and sale terms are provided. When a potential buyer visits the website using the URL with its unique media and property codes designated in the advertisement, the system tells the seller and auctioneer, or individual seller or auctioneer, which advertisement generated the visit. In addition, the system calculates the cost of the visit by analyzing the cost of the advertisement in relation to the number of visitors generated by that advertisement.

The system also tracks the cost associated with prospective buyer registrations regarding the property. When visitors to the auction website are interested in a property, they must register with the website to gain access to detailed information regarding a specific property. By analyzing the cost of an advertisement in relation to the number of visitors who register on the website, the system calculates the cost of each registration.

The system also tracks the advertising cost associated with prospective buyers who use the review and download section of the property profile page. On the auction website, each property for sale has its own dedicated property profile page. Incorporated into this page, is a section allowing prospective buyers to obtain detailed property information. In order to ascertain the value of an advertisement, the system of the present invention calculates the cost of individual advertisements in relation to the number of visitors who download information about the property identified in each respective advertisement.

The system also tracks the advertising cost associated with a prospective buyer who visits the property, the cost associated with a prospective buyer who submits a bid for the property, and finally, the cost associated with a prospective buyer who becomes the winning bidder for the property. Each of these calculations is made by analyzing the number of visits, bids, and eventually the winning bid, with regard to the media tracking code of a particular advertisement. By ascertaining the cost of each individual advertisement, and tracking the above described milestone events, a seller or auctioneer can determine in real time, the cost effectiveness of each advertisement placed for a given property. This knowledge allows a seller or auctioneer to make informed, cost effective decisions regarding the placement of future advertisements.

The system generates a number of reports for sellers and auctioneers to gauge the effectiveness of a particular advertisement against others. The system is then able to attach a cost per response valuation to every type of advertising in an auction marketing campaign. Advertisements that are inexpensive and generate a large number of potential bidders can be preferred over advertisements that generate little interest. In addition, a cost per respondent value can be tracked through the auction process.

In addition to generating reports based on media and prospect data, the system also performs an automatic prospect grading function. The website automatically grades each prospective buyer. In one preferred embodiment, a grading scale of A through F is used. Other preferred embodiments include other alphanumeric scales, and percentile grading. The grading function operates on a series of objective criteria. In a preferred embodiment of the system, grades are based on: the number of visits to the property profile page, the amount of time actually spent by a prospect viewing the an individual property profile page, and the number of property-specific document downloads obtained by a prospective buyer.

A second grading function is simultaneously performed in the system by the auction manager and/or the property representative. This second grading function is a subjective grade applied to each prospect based on the interaction between the prospective buyer and the auction manager and/or property representative during the course of the marketing campaign. The system performs a matching function, wherein the objective grades, based on the prospective buyer's activities on the website, are matched to the subjective grades assigned to the prospective buyer by the auction manager and/or the property representative. By matching these two grades, the automated grading system of the invention allows the auction manager and the property representative to focus their attention and communication on prospective buyers who are more likely to be the winning bidder at the auction.

### FIGURES

FIG. 1 is an illustration of the main prospect tracking system webpage in accordance with the media tracking system of the present invention.

FIG. 2 is an illustration of a media tracking report webpage in accordance with the media tracking system of the present invention.

FIG. 3 is an illustration of a prospect activity report webpage in accordance with the media tracking system of the present invention.

FIG. 4 is an illustration of an account details webpage accessible by a property seller or auctioneer in accordance with the media tracking system of the present invention.

FIG. 5 is an illustration of a prospect registration webpage in accordance with the media tracking system of the present invention.

FIG. 6 is an illustration of a cost per property chart, showing media costs at various stages of an auction in accordance with the media tracking system of the present invention.

FIG. 7 is an illustration of a media ranking chart, showing the cost per registration, and ranking media on that basis in accordance with the media tracking system of the present invention.

### REFERENCE NUMERALS

10 . . . Media Tracking Report Columns
11 . . . Advertiser Number
12 . . . Advertiser Media Code
13 . . . Advertiser Summary
14 . . . Advertisement Comencement Date
15 . . . Advertisement Cost
16 . . . Hits Generated By Advertisement
17 . . . Cost Per Hit
18 . . . Total Property Registrations
19 . . . Cost Per Registration
20 . . . Prospect Activity Report
21 . . . Prospect Grade

### DETAILED DESCRIPTION

In the media/prospect tracking system of the present invention, visits by prospective buyers to an online auction web site generate feedback for sellers and auctioneers, allowing sellers and auctioneers to determine the value of advertising from various media sources. By assessing the value of advertising media, sellers and auctioneers are able to place advertisements more effectively, in those media outlets that provide the most exposure to potential buyers and produce the most cost effective results.

In the method and system of the present invention, advertisements are tracked with the help of property and media codes. During a real property auction or sale, each type of advertisement: print media, Internet, signage, etc., is designated with a media code. Each media code carries with it a designation of the type of media associated with the advertisement, as well as denoting the advertiser and property in question.

By using media codes, sellers and auctioneers can determine the cost of advertising on a real-time basis, and according to individual properties. In addition, the system monitors data at various milestones while the property remains on the market. Although milestones may be customized to meet specialized criteria, the following six default milestones are automatically monitored by the system:

First, the system tracks the advertising cost associated with prospective buyer visits to the property profile page. The media codes of the present invention consist of an alphanumeric code incorporated into the URL of a website. The website contains details of the property and sale terms. When a potential buyer visits the website using the media code embedded URL designated by an advertisement, the system tells the seller and auctioneer which advertisement generated the visit. In addition, the system calculates the cost of the visit by analyzing the cost of the advertisement in relation to the number of visitors generated by that advertisement.

Second, the system tracks the advertising cost associated with prospective buyer registrations regarding the property. When visitors to the auction website are interested in a property, they must register with the website to gain access to detailed information regarding an auction. By analyzing the cost of an advertisement in relation to the number of visitors who register for an individual auction, the system calculates the cost of each registration.

Third, the system tracks the advertising cost associated with prospective buyers use of the review and download section of the property profile page. On the auction website, each property for sale is listed on its own property profile page. Incorporated into this page, is a section allowing prospective buyers to obtain detailed property information. In order to ascertain the value of an advertisement, the system of the present invention calculates the cost of each advertisement in relation to the number of visitors who download information about a property for sale.

Fourth, the system tracks the advertising cost associated with prospective buyer visits to the property,

Fifth, the system tracks the advertising cost associated with bids placed by prospective buyers for the property.

Finally, the system tracks the advertising cost associated with buyer who places the winning bid for the property. This cost can be compared to the advertising cost for other similar sold properties which helps the seller and auctioneer determine the best advertising media to be used for future auction sales of similar property.

Each of these calculations is made by analyzing the number of visits to the site, the source of the bids, and the winning bid, with regard to the media tracking code of a particular advertisement. By determining the cost associated with each advertisement, a seller or auctioneer can ascertain the advertisements that are most effective, as well as those that have the greatest return on investment.

The system generates a number of reports for sellers and auctioneers, allowing them to gauge the effectiveness of a particular advertisement and compare it against others. The system attaches a cost per response valuation to every type of advertising in a property marketing campaign. Advertisements that are inexpensive and generate a large number of potential bidders can be preferred over advertisements that generate little interest. In addition, a cost per respondent value can be tracked through the auction process.

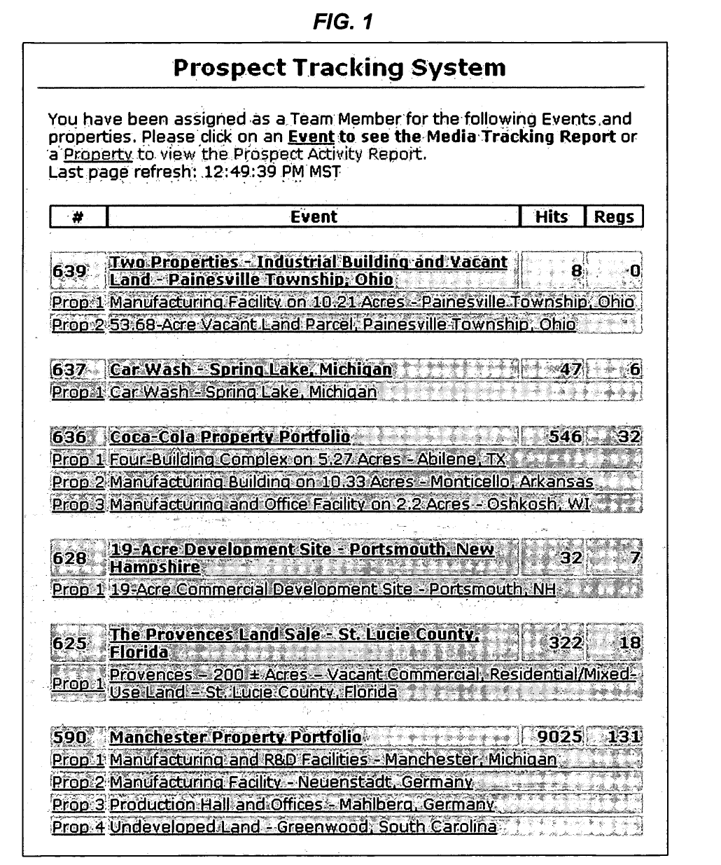

Referring to FIG. 1, the media tracking system of the present invention assigns a variety of property auction events to an individual user. The events are cataloged on a web page, and users of the system may select among auction events, which will direct them to a media tracking report webpage, where information about the auction is contained. In addition, users may select individual properties within auction events, which will direct them to a property activity report page, where information about specific properties within an auction event are displayed.

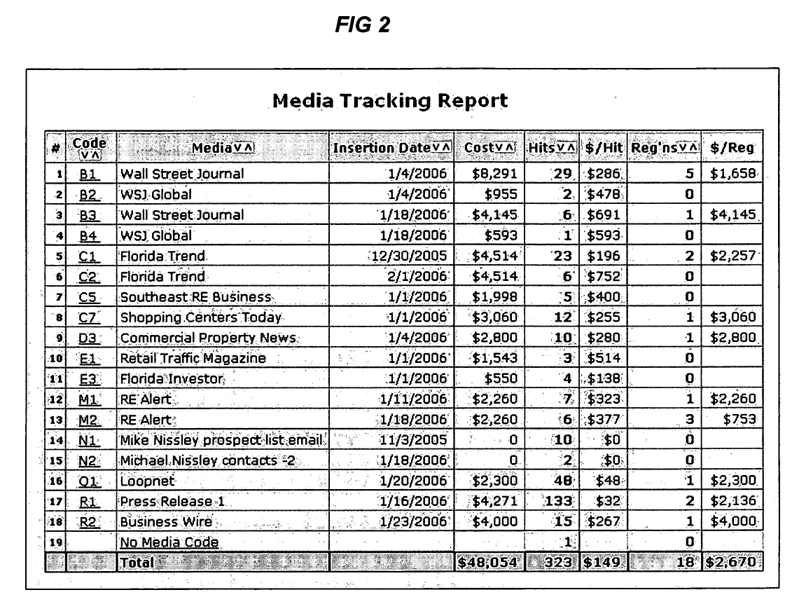

Referring to FIG. 2 the media tracking system of the present invention generates a media tracking report. The media tracking report addresses the cost per visit and cost per registration milestones. The media tracking report comprises a spreadsheet style table 10 containing data regarding the property.

In the columns of the report 10, individual advertisers are listed by number 11, their specific media code 12, a brief description of the advertiser 13, including the date 14 the advertisement was employed, the overall cost 15 of the advertisement, the number of visits or “hits” 16 generated by the advertisement, the cost per hit 17, the total number of registrations 18 and the cost per registration 19. The report excludes hits from the seller and auctioneer, as well as early hits generated before the effective date of each advertisement.

As shown in line one of FIG. 2 for example: if an advertisement in the Wall Street Journal costs $8291 and receives 29 responses, each response is valued at $286. If 5 of the 29 responses register on the website, each registration is valued at $1658.

This system, besides taking into account the milestones and their calculations, stores and generates records of prospects for property available at auction on the website, by tracking visitations, hits and registrations for each property in relation to each advertisement.

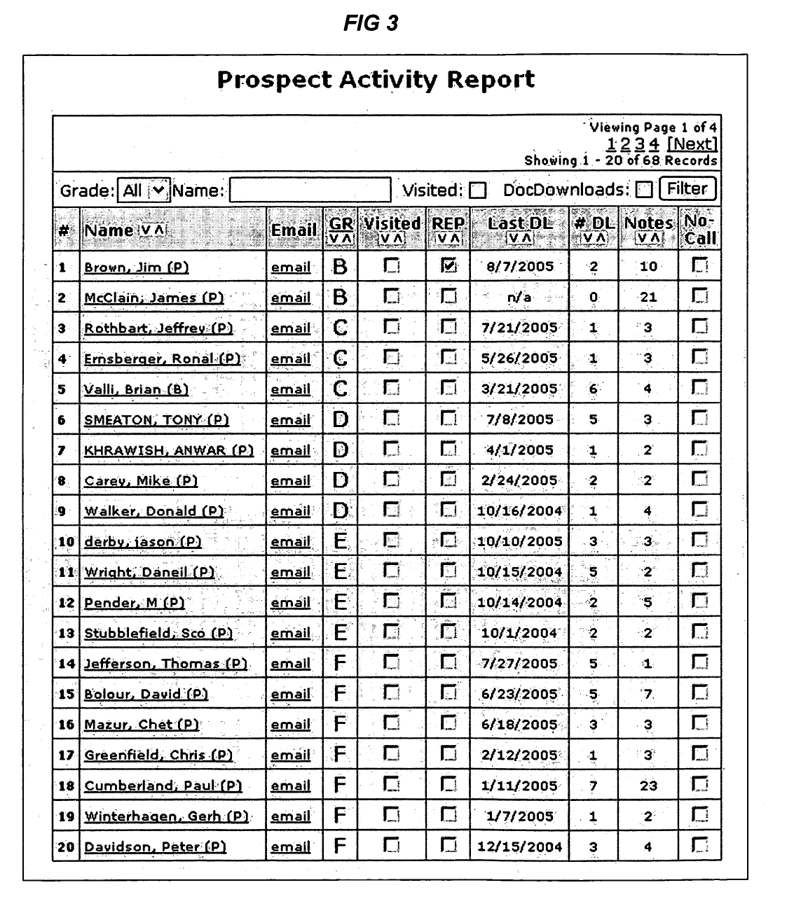

Referring to FIG. 3, in addition to generating reports based on buyer and media data, the system also performs an automatic prospect grading function. The website automatically grades each prospective buyer. In one preferred embodiment, a grading scale of A through F is used. Other preferred embodiments include other alphanumeric scales, and percentile grading. The website grading function operates on a series of objective criteria. In a preferred embodiment of the system, grades are based on the number of visits to the property profile page, the amount of time actually spent viewing the property profile page, and the number of document downloads obtained by a prospective buyer.

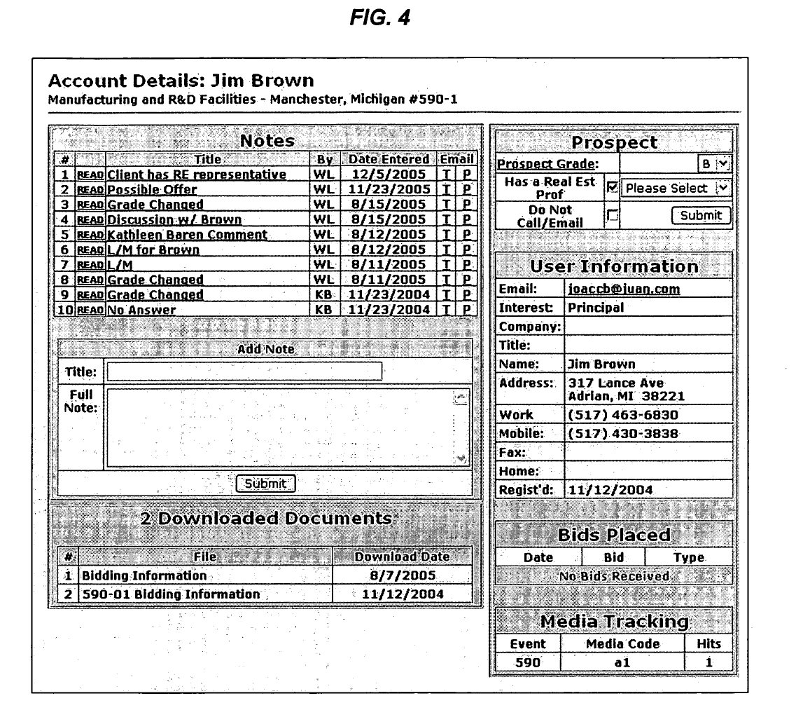

Referring to FIG. 4, a second grading function is simultaneously performed in the system by the property representative. This second grading function is a subjective grade applied to each prospective buyer by the property representative, based on the interaction between the prospective buyer and the representative during the course of the marketing campaign. The system provides a webpage for account details entered by a property representative regarding each prospect. The account details webpage includes prospect and user information fields, and the ability to record notes regarding the prospect before and during an auction. In addition, the account details function allows a property representative to monitor a prospective buyer's download activity.

The system also performs a matching function, wherein the objective grades, based on the prospective buyer's activities on the website are matched to the subjective grades assigned to the prospective buyer by the property representative. By matching these two grades, the automated grading system of the invention allows property representatives to focus marketing efforts on prospective buyers who are more likely to be the winning bidder in an auction.

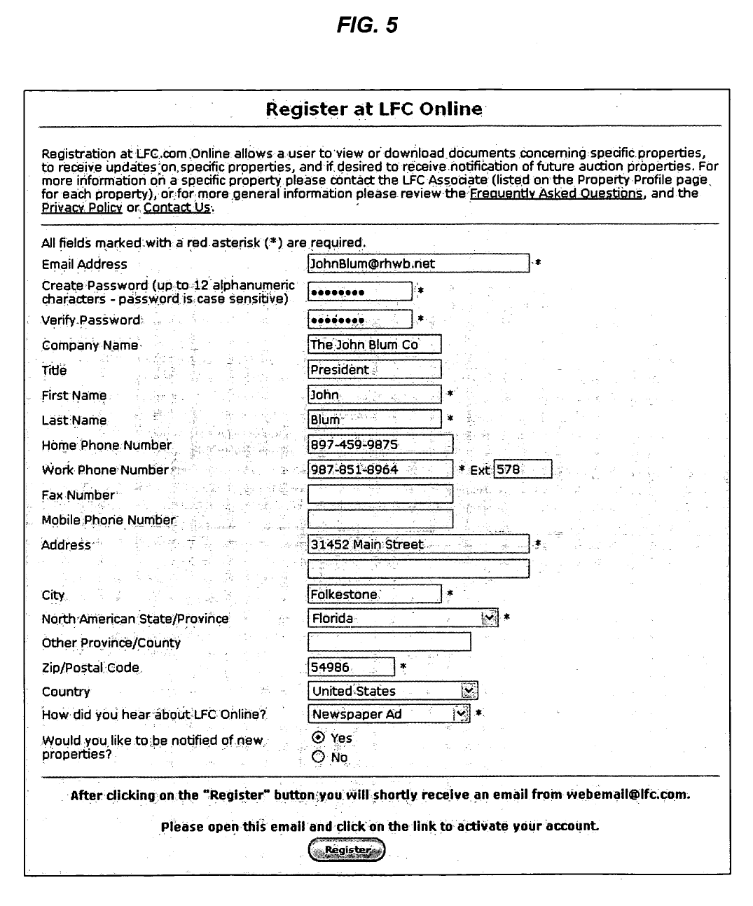

Referring to FIG. 5, the system provides a registration page where prospective buyers may register to access details regarding auctioned properties. Upon registration, the system tracks a users activities regarding properties visited, and documents downloaded, among other information, which can be accessed by property representatives with the prospect activity report function.

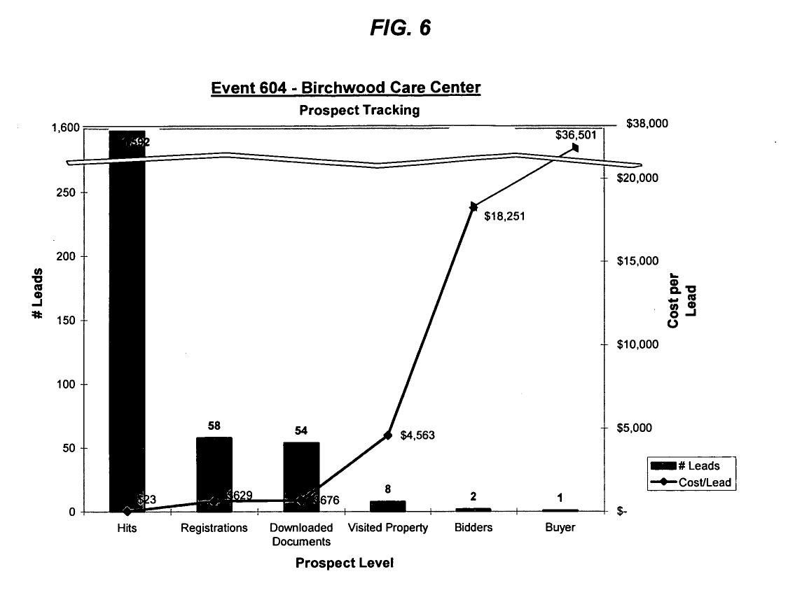

Referring to FIG. 6, in a preferred embodiment of the present invention, the system tabulates the data gathered from prospect tracking to graphically display the cost per hit for an auctioned property, along with the cost per registration, cost per number of downloaded documents regarding a property, cost per visit to a property, cost per bidder, and ultimately, the cost associated with obtaining a buyer for the property.

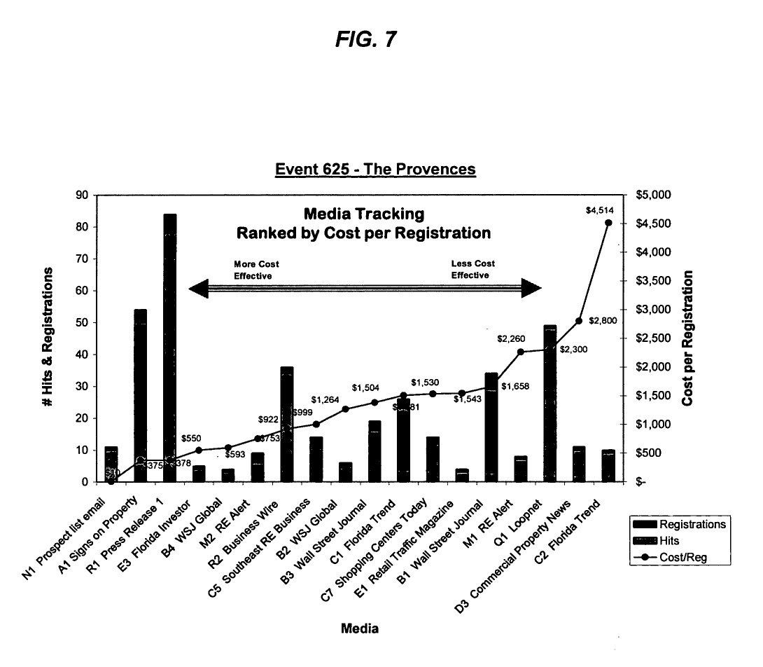

Referring to FIG. 7, also in a preferred embodiment of the present invention, the system tabulates the number of hits and registrations generated by various media sources in order to graphically show the cost effectiveness of each source. In this manner, sellers and auctioneers of property may target more effective media sources for future auctions of property with similar profiles.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A method and system for tracking media that advertises real estate auction sales comprised of the following steps;
a. generating a tracking code for a property for every instance where the property is listed for sale or auction in any medium;
b. incorporating the tracking code into the URL of every media source on which the property is listed or described;
c. collecting data, including the tracking code, each time a potential property buyer logs onto the web page on which the property is listed or described;
d. assembling and presenting the data into various tracking reports, wherein the media codes and their associated media sources are displayed along with date of each advertisement and the number of times the URL of the web page is accessed;
e. employing the data derived from the various tracking reports to determine which advertisements are the least expensive and most effective on a cost per hit basis.

2. The method and system of claim 1, wherein the tracking report contains an identifier of the media source and code, the date the advertisement was listed, the total cost of the advertisement, the number of hits generated by the advertisement, and the cost per hit based on the total cost of the advertisement.

3. The method and system of claim 2, wherein the dates of the first hit and last hit may be modified to retrieve data from specific date ranges.

4. The method and system of claim 1, wherein the tracking report contains an identifier of the media source and code, the date the advertisement was listed, the total cost of the advertisement, the number of user registrations generated by the advertisement, and the cost per registration hit based on the total cost of the advertisement.

5. The method and system of claim 4, wherein the dates of the first registration and last registration may be modified to retrieve data from specific date ranges.

6. The method and system of claim 1, wherein the tracking report contains an identifier of the media source and code, the date the advertisement was listed, the total cost of the advertisement, the number of times users have activated a property review and download feature to download information regarding the property to their local computer, and the cost per download and review based on the total cost of the advertisement.

7. The method and system of claim 6, wherein the dates of the first registration and last registration may be modified to retrieve data from specific date ranges.

8. The method and system of claim 1, wherein the tracking report contains an identifier of the media source and code, the date the advertisement was listed, the total cost of the advertisement, the number of times users have visited the property, and the cost per visit based on the total cost of the advertisement.

9. The method and system of claim 8, wherein the dates of the first registration and last registration may be modified to retrieve data from specific date ranges.

10. The method and system of claim 1, wherein the tracking report contains an identifier of the media source and code, the date the advertisement was listed, the total cost of the advertisement, the number and amount of bids users have made on the property, and the cost per bid based on the total cost of the advertisement.

11. The method and system of claim 10, wherein the dates of the first registration and last registration may be modified to retrieve data from specific date ranges.

12. The method and system of claim 1, wherein the tracking report contains an identifier of the media source and code, the date the advertisement was listed, the total cost of the advertisement, and details regarding the winning bid for the property, including the amount of the bid, previous bids made by the winning bidder, and bids by other bidders for the same property.

13. The method and system of claim 10, wherein the dates of the first registration and last registration may be modified to retrieve data from specific date ranges.

14. The method and system of claim 1, wherein a grading system is used, wherein;
a. an objective grade is assigned to prospective buyers by monitoring and recording, and assessing their use of the site,
b. a subjective grade is assigned to prospective buyers by a property representative or seller based on the representative's impression of the buyers from interactions during a marketing campaign, and
c. the objective and subjective grades are matched to reveal to property representative buyers or sellers, which prospective buyers are most likely to submit a winning bid for a property.
